(19) United States
(12) Patent Application Publication
(10) Pub. No.: US 2006/0209155 A1
(43) Pub. Date: Sep. 21, 2006

(54) Method and device for continuously feeding media in image forming apparatus

(75) Inventors: Ho-bin Hwang, Suwon-si (KR); Sang-hyup Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/378,474

(22) Filed: Mar. 20, 2006

(30) Foreign Application Priority Data
Mar. 21, 2005 (KR) 10-2005-0023241

(51) Int. Cl. B41J 2/01

(52) U.S. Cl. 347/104

(57) ABSTRACT

Provided are a method and device for calculating a distance between conveyed media based on a feeding speed of the media selected by a user and continuously picking up and feeding the media based on the calculated distance. The method involves selecting a distance between the media along the print path of the image forming apparatus, calculating a conveying distance of a first medium at the time when a second medium is picked up after the front end of the first medium is detected based on the selected distance, and picking up and feeding the second medium using the calculated conveying distance of the first medium.

### CROSS-REFERENCE TO RELATED PATENT APPLICATIONS

This application claims the benefit under 35 U.S.C. §119(a) of Korean Patent Application No.10-2005-0023241, filed on Mar. 21, 2005, in the Korean Intellectual Property Office, the entire disclosure of which is incorporated herein in its entirety by reference.

### BACKGROUND OF THE INVENTION

1. Field of the Invention

The present invention relates to an image forming apparatus. More particularly, the present invention relates to a method and device for feeding media by calculating a distance between conveyed media based on a feeding speed of the media selected by a user and successively picking up the media based on the calculated distance.

2. Description of the Related Art

It is important for an image forming apparatus such as a laser printer, an inkjet printer, or a fax machine to control the relative timing of the feeding of media and the printing of an image on the media. Particularly, during a continuous printing operation in which a predetermined image is continuously printed on media, it is important to control the timing of picking up the media to feed the media in succession and at high speed.

FIG. 1 is a schematic diagram of a conventional device for continuously feeding media in an image forming apparatus. Referring to FIG. 1, a medium stacked in a feeding tray 110 is picked up by a pick-up roller 120, and a rear end of the medium is detected by a sensor unit 130 while the medium is fed to a conveying path. The sensor unit 130 comprises a light emitting unit (not shown) and a light detecting unit (not shown). The light emitting unit emits light such as white light onto the medium conveyed along the conveying path. The light detecting unit detects the rear end of the medium based on the intensity of light reflected by the medium.

When the rear end of the medium is detected by the sensor unit 130, the next medium is picked up by the pick-up roller 120 while the currently conveyed medium is conveyed to a print engine unit 150 by a conveying roller 140 and a predetermined image is printed onto the currently conveyed medium.

To continuously feed a medium, the conventional media feeding device picks up the next medium at the time when the sensor unit 130 detects the rear end of a medium. However, since a subsequent medium can be fed only after the rear end of a previous medium is detected, there is a delay due to the distance between a point where the medium is picked up and the sensor unit 130, thus reducing the feeding speed of the conventional media feeding device.

Accordingly, a need exists for a system and method which improve the feeding speed of a device for continuously feeding media along a print path in an image forming apparatus.

### SUMMARY OF THE INVENTION

The present invention provides a method of calculating a distance between conveyed media based on a feeding speed of the media selected by a user and continuously picking up and feeding the media based on the calculated distance.

The present invention also provides a device for calculating a distance between conveyed media based on a feeding speed of the media selected by a user and continuously picking up and feeding the media based on the calculated distance.

The present invention also provides a method of feeding media by compensating for an error between a selected distance and a measured distance so that the distance between a currently conveyed medium and a medium to be subsequently picked up is compensated.

The present invention also provides a device for feeding media by compensating for an error between a selected distance and a measured distance so that the distance between a currently conveyed medium and a medium to be subsequently picked up is compensated.

According to an exemplary aspect of the present invention, there is provided a method of continuously feeding media along a print path in an image forming apparatus, the method comprising: selecting a distance between the two consecutive media along the print path of the image forming apparatus, calculating a conveying distance of a first medium, at the time when a second medium is picked up after the front end of the first medium is detected, based on the selected distance, and picking up and feeding the second medium when the first medium has moved the calculated conveying distance.

The method may further comprise displaying feeding speeds of media prior to the selecting the distance.

The selecting the distance may comprise selecting a predetermined feeding speed from the displayed feeding speeds of media, and calculating the distance between the media to be conveyed based on the selected feeding speed.

The step of picking up and feeding the second medium may comprise detecting the front end of the first medium, measuring the conveying distance of the first media after detecting the front end of the first medium, and picking up and feeding the second medium at the time when the first medium is conveyed as much as the conveying distance.

The method may further comprise: calculating a compensated distance to compensate for an error between the selected distance between the first and second media and a measured distance between the first and second media, and compensating for a conveying distance of the second medium at which a third medium is picked up based on the compensated distance.

The step of calculating the compensated distance may comprise measuring a distance between a position where the front end of the first medium is detected and a position where the rear end of the first medium is detected, and calculating the compensated distance to compensate for the error between the measured distance and the selected distance such that the measured distance is adjusted to the selected distance.

The step of calculating the compensated distance may comprise calculating the error between the selected distance and the measured distance, calculating a value for compensating for the error between the selected distance and the measured distance, and calculating the compensated distance based on the calculated compensation value.

According to another exemplary aspect of the present invention, there is provided a device for continuously feeding media along a print path in an image forming apparatus, the device comprising: a user interface unit for selecting a feeding speed of media, a calculating unit which calculates a pick-up time of a second medium that is fed subsequent to a first medium based on the selected feeding speed, a predetermined length of media and an interval between media, and a control unit which controls the second medium to be picked up and fed at the calculated pick-up time of the second medium.

The device may further comprise a display unit which displays possible feeding speeds of the media, wherein the feeding speed is selected from the displayed feeding speeds.

The device may further comprise a compensating unit which compensates for an error between the distance calculated by the first calculating unit and a measured distance.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a conventional device for continuously feeding media in an image forming apparatus;

FIG. 2 is a block diagram of a continuous media feeding device according to an exemplary embodiment of the present invention;

FIG. 3A is a table showing an example of the feeding speeds displayed on a display unit of the device shown in FIG. 2;

FIG. 3B shows an example of feeding speed modes used by the continuous media feeding device illustrated in FIG. 2;

FIG. 4 is a detailed block diagram of a calculating unit and a control unit of the device shown in FIG. 2;

FIG. 5 is a perspective view of the counter unit of FIG. 4;

FIG. 6 is a diagram for explaining in detail a conveying distance of media in the device shown in FIG. 2;

FIG. 7 is a diagram of a continuous media feeding device according to another exemplary embodiment of the present invention;

FIG. 8 is a block diagram of a compensating unit of the continuous media feeding device illustrated in FIG. 7;

FIG. 9 is a flowchart illustrating a method of continuously feeding media according to an exemplary embodiment of the present invention;

FIG. 10 is a flowchart illustrating in detail an operation of selecting a distance included in the method illustrated in FIG. 9;

FIG. 11 is flowchart illustrating a method of continuously feeding media according to another exemplary embodiment of the present invention; and

FIG. 12 is a flowchart illustrating in detail an operation of calculating a compensated distance included in the method illustrated in FIG. 11.

Throughout the drawings, like reference numerals will be understood to refer to like parts, components and structures. Descriptions of well-known functions and constructions are omitted for clarity and conciseness.

### DETAILED DESCRIPTION OF THE EXEMPLARY EMBODIMENTS

FIG. 2 is a block diagram of a continuous media feeding device according to an exemplary embodiment of the present invention. Referring to FIG. 2, the device comprises a user interface unit 210, a display unit 220, a storage unit 230, a calculating unit 240, and a control unit 250.

A user inputs a user command to select a feeding speed through the user interface unit 210. The feeding speed is the number of media that are picked up from a feeding tray and conveyed through a print path per unit time. The user command for selecting the feeding speed may be input by user's voice or a key pad including a selection key button. Other methods can be used to input the user command for selecting the feeding speed without departing the scope of the present invention.

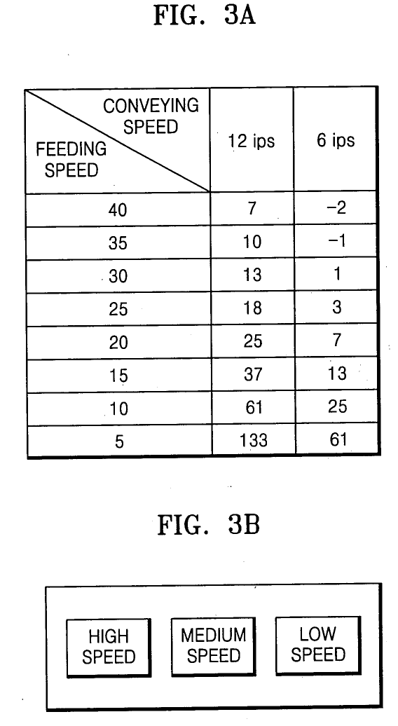

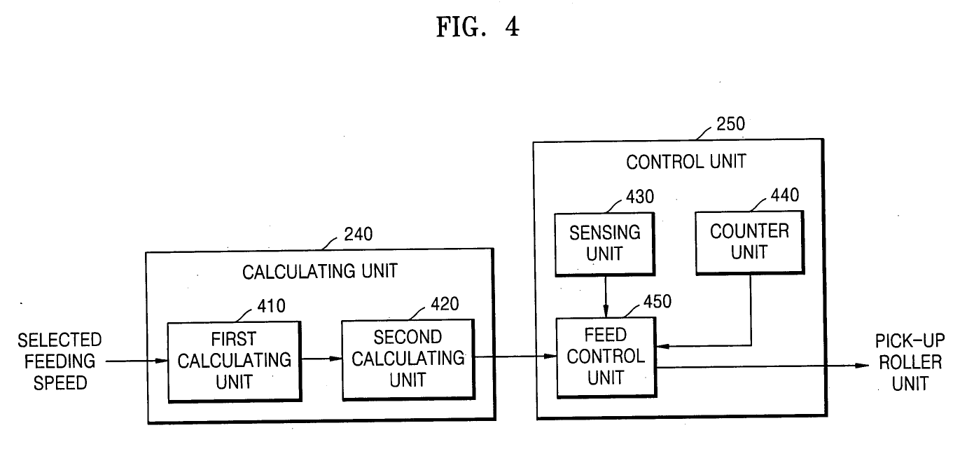

When the user command for selecting the feeding speed is input to the display unit 220 through the user interface unit 210, the display unit 220 displays the feeding speed or a feeding mode stored in the storage unit 230. FIG. 3A is a table of exemplary feeding speeds that can be displayed on the display unit 220.

Referring to FIG. 3A, the leftmost column in the table shows the number of media fed per one minute, and the other columns in the table show the distance Gs between a first medium and a second medium that are sequentially fed at the conveying speed of the media such as the conveying speeds of 12 inches per second (ips) and 6 ips, respectively. An item displayed on the display unit 220 may be the number of media fed per unit time. FIG. 3B shows examples of feeding speed modes. A dialogue box, for example, for selecting a feeding mode from among a high-speed feeding mode, a medium-speed feeding mode, and a low-speed feeding mode is displayed on the display unit 220, and the user selects a feeding mode through the user interface unit 210 according to the kind of media and a kind of image to be printed.

The user may also input the number of media fed per unit time or the feeding mode with his/her voice or a key pad through the user interface unit 210 without the feeding speed or feeding mode being displayed on the display unit 220.

Referring again to FIG. 2, when the feeding speed is input through the user interface unit 210, the calculating unit 240 determines the distance Gs between the media based on the feeding speed. A conveying distance P1 of the first media, at the time when the second media is picked up after the first media is picked up and conveyed, is calculated based on the calculated distance Gs. According to another embodiment of the present invention, the distance Gs between media based on the selected feeding mode which is previously calculated and stored in the storage unit 230 is mapped instead of being calculated by the calculating unit 240, and the conveying distance P1 of the first media, at the time when the second medium is picked up after the first medium is picked up and conveyed, is calculated based on the mapped distance Gs.

The control unit 250 controls a pick-up roller unit to pick up and feed the second medium when the first medium has moved the conveying distance P1 calculated by the calculating unit 240.

FIG. 4 is a detailed block diagram of the calculating unit 240 and the control unit 250 shown in FIG. 2. Referring to FIG. 4, the calculating unit 240 comprises a first calculating unit 410 and a second calculating unit 420. When receiving the feeding speed selected through the user interface unit 210, the first calculating unit 410 calculates a distance Gs between media based on the feeding speed. For example, when the size of a fed medium is 8.5×11 inches, the medium is conveyed at a rated speed of 12 ips and the feeding speed selected through the user interface unit 210 is Y pages per minute (ppm)=Y/60 pages per second (pps), the sum of the size of the fed medium and the distance X between media is (11+X) inches, and therefore,

$$( 11 + X ) / 12 ( \frac{seconds}{page} ) = 60 / Y ( \frac{seconds}{page} ) .$$

Then, Gs, that is, the distance X between the media corresponding to the feeding speed selected through the user interface unit 210, is calculated by Equation (1 ) below:
X=720/Y−11 (1 )

The feeding speed of the medium is determined by the quality of an image that a user wants to print, the print resolution of an image printing device, the speed of injection of toner from a printhead unit, and so on.

By using the distance Gs between the media which has been calculated by the first calculating unit 410, the second calculating unit 420 calculates the conveying distance P1 of the first medium at the time when the second medium is picked up after the first medium is picked up and fed. The conveying distance P1 calculated by the second calculating unit 420 is defined by Equation (2) below:
P1=L1−(G1−Gs) (2)
where L1 denotes the length of the medium currently fed, G1 denotes an interval between the conveyed media, and Gs denotes the distance between the conveyed media. In other words, G1 denotes the distance between the media when the continuous feeding is performed using the conventional continuous feeding method. L1 is a value that is previously set by a manufacturer when manufacturing of the continuous media feeding device, and G1 is a measured fixed constant. On the other hand, Gs is calculated as described above based on a feeding speed value that the user selects through the user interface unit 210. Media are fed with the distance Gs selected through the user interface unit 210 therebetween based on Equation (2). It is to be understood that a single calculating unit can be used to calculate Gs and P1.

According to the present embodiment, when media are conveyed at a predetermined conveying speed, the distance Gs between the media corresponding to the selected feeding speed is previously calculated and stored in the storage unit 230. When the feeding speed is selected by the user interface unit 210, the distance Gs corresponding to the selected feeding speed is directly mapped, and the second calculating unit 420 calculates the conveying distance P1 using the mapped distance Gs.

The control unit 250 comprises a sensing unit 430, a counter unit 440, and a feed control unit 450. The sensing unit 430 detects the front end or the rear end of the conveyed medium. Further, the sensing unit 430 comprises a light emitting unit (not shown) that emits predetermined light and a light detecting unit (not shown) that receives the light emitted from the light emitting unit, and detects the front end or the rear end of the conveyed medium based on the intensity of the received light. The counter unit 440 measures the conveying distance of the first media after the front end of the first medium is detected by the sensing unit 430.

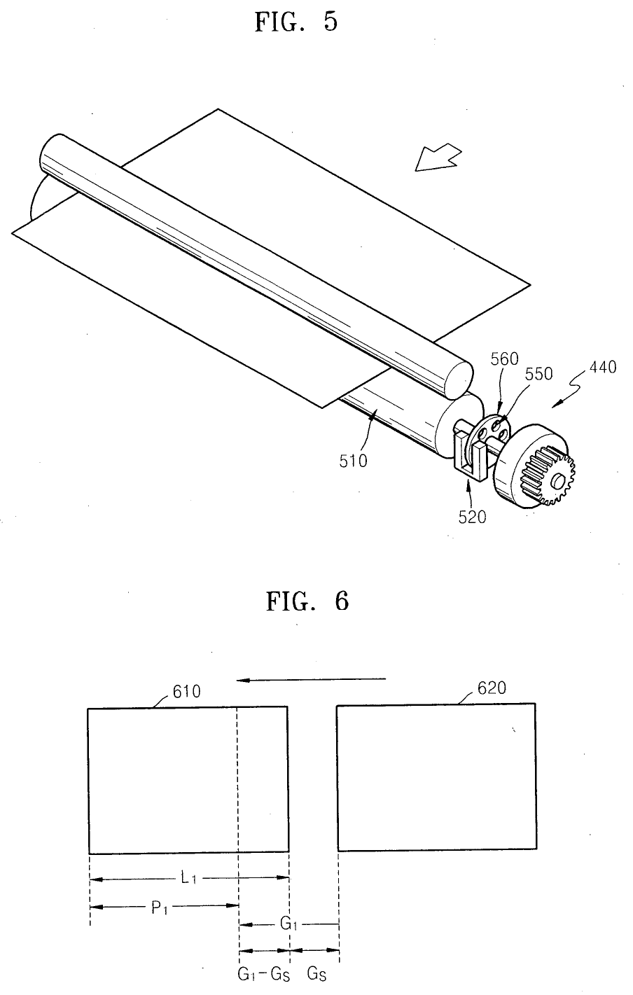

FIG. 5 is a perspective view of the counter unit 440 of FIG. 4. Referring to FIG. 5, an encoder 560 connected to a register roller 510 is disk-shaped with a plurality of holes 550 disposed at regular intervals. An encoder sensor 520 detects the rotation of the register roller 510 by detecting light passing through the holes 550. The encoder sensor 520 generates an electric signal depending on whether or not the encoder sensor 520 detects the light. For example, the encoder sensor 520 generates a high signal when detecting the light passing through the holes 550, and generates a low signal when unable to detect the light. Since the holes 550 are arranged at regular intervals, the conveying distance of the medium can be measured by counting the transitions between high and low signals.

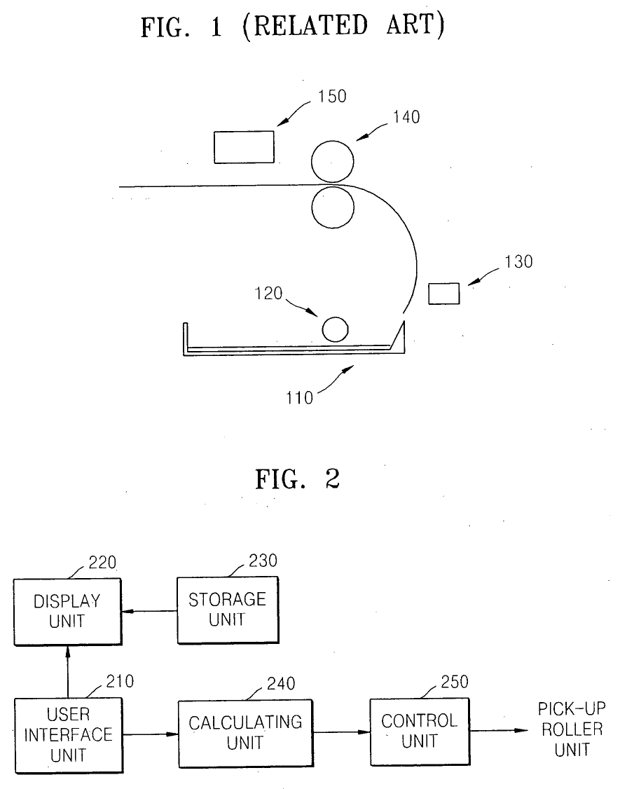

Referring back to FIG. 4, the feed control unit 450 controls the pick-up roller (e.g., pick up roller 120 in FIG. 1) such that the second medium is picked up and fed when the first medium is conveyed the conveying distance P1 after the front end of the first medium is detected.

FIG. 6 is a diagram for explaining in detail the conveying distance P1 according to an exemplary embodiment of the present invention. Referring to FIG. 6, a first medium 610 and a second medium 620 are picked up and conveyed along the conveying path. The lengths of both the first medium 610 and the second medium 620 are L1, an interval between the first medium 610 and the second medium 620 is G1, and the distance between the first medium 610 and the second medium 620 to be conveyed is Gs. The conveying distance (P1=L1−G1+Gs) of the first medium 610, at the time when the second medium 620 is picked up after the first medium 610 is picked up and conveyed, is calculated based on the distance Gs selected through the user interface unit 210.

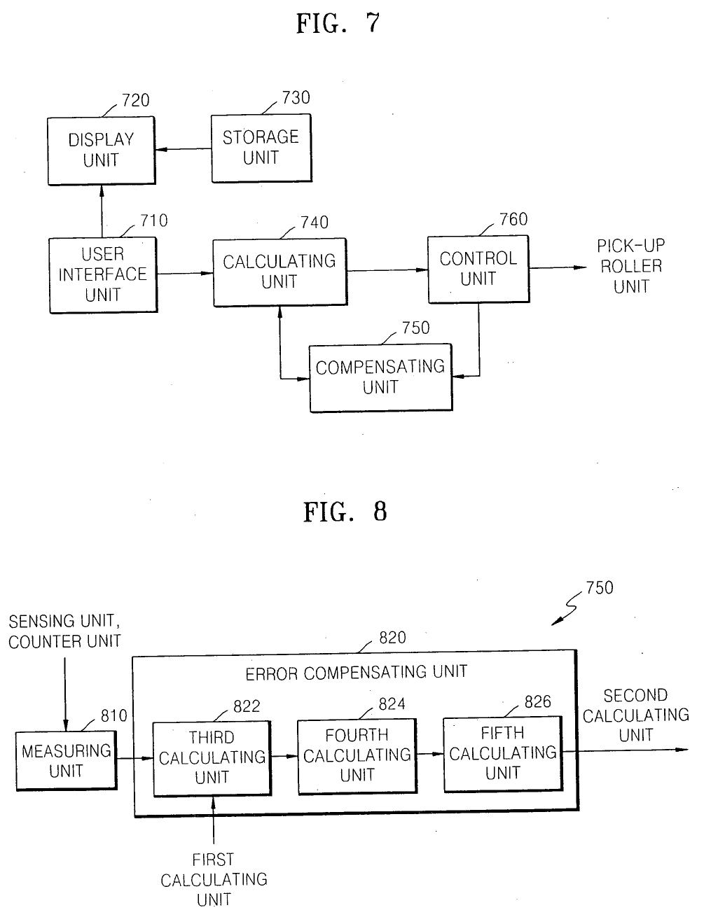

FIG. 7 is a diagram of a continuous media feeding device according to another exemplary embodiment of the present invention. Referring to FIG. 7, the continuous media feeding device comprises a user interface unit 710, a display unit 720, a storage unit 730, a calculating unit 740, a compensating unit 750, and a control unit 760. The user interface unit 710, the display unit 720 and the storage unit 730 are the same as the user interface unit 210, the display unit 220 and the storage unit 230 of FIG. 2 and the descriptions will be omitted for conciseness.

The calculating unit 740 comprises a first calculating unit (not shown) and a second calculating unit (not shown). The first calculating unit calculates a distance Gs between media conveyed based on a feeding speed selected through the user interface unit 710. The second calculating unit calculates a conveying distance P1 of a first medium, at the time when a second medium is picked up after the first medium is picked up and conveyed, based on the calculated distance Gs. It is to be understood that a single calculating unit can be used to calculate Gs and P1.

The control unit 760 comprises a sensing unit (not shown), a counter unit (not shown), and a feed control unit (not shown), and controls the pick-up time of the second medium based on the conveying distance P1 of the first medium calculated by the second calculating unit.

The compensating unit 750 recalculates a distance Next-Gs between the second medium and a third medium to compensate for an error between the distance between the selected distance Gs and a measured distance Gs_curr between the first medium and the second medium. FIG. 8 is a block diagram of the compensating unit 750 of FIG. 7.

Referring to FIG. 8, the compensating unit 750 comprises a measuring unit 810 and an error compensating unit 820. The rear end of the first medium and the front end of the second medium are detected by the sensing unit (not shown), and the measuring unit 810 measures the distance Gs_curr between the first medium and the second medium using a counter unit (not shown) from the time when the rear end of the first medium is detected to the time when the front end of the second medium is detected.

The error compensating unit 820 comprises a third calculating unit 822, a fourth calculating unit 824, and a fifth calculating unit 826. The third calculating unit 822 calculates the error Gs_err between the distance Gs_curr measured by the measuring unit 810 and the distance Gs calculated by the first calculating unit. The fourth calculating unit 824 calculates a value Gs_com for compensating for the error Gs_err between the distance Gs and the measured distance Gs_curr.

In the present embodiment, a proportional integral derivative (PID) control method is preferably used to calculate the compensation value Gs_com. In the PID control method, the compensation value Gs_com is obtained from Equation (3) below.
Gs_{—}com=KP Gs_{—}err+KI Gs_{—}err_{—}sum+KD Gs_{—}err_{—}div (3)
where KP, KI, and KD denote a proportional coefficient, an integral coefficient, and a differential coefficient, respectively. The proportional coefficient, the integral coefficient, and the differential coefficient are set to optimal values through gain tuning. For example, if the distance Gs calculated from the input to the user interface unit 710 is 10 mm and the actually measured distance Gs_curr is 9 mm, the compensation value Gs_com is calculated using the Equation (3) to compensate for 1 mm, which is the error between the selected distance Gs and the measured distance Gs_curr. The compensation value Gs_com can be calculated using another method in the field to which the present invention pertains without departing from the scope of the present invention.

The fifth calculating unit 826 calculates the distance Next_Gs between the third medium and the second medium using the calculated compensation value Gs_com and the actually measured distance Gs_curr. The distance Next_Gs between the third medium and the second medium is obtained from Equation (4) below.
Next_{—}Gs=Gs_{—}curr+Gs_{—}com (4)

The second calculating unit of the control unit 760 calculates a conveying distance P2 of the second medium at which the third medium is picked up by using the distance Next_Gs between the third medium and the second medium through Equation (5) below.
P2=L1−(G1−Next_{—}Gs) (5)

The pick-up time of the third medium is compensated using the conveying distance of the second medium calculated by the second calculating unit, and accordingly, the distance between the conveyed media is adjusted to the distance selected through the user interface unit 710.

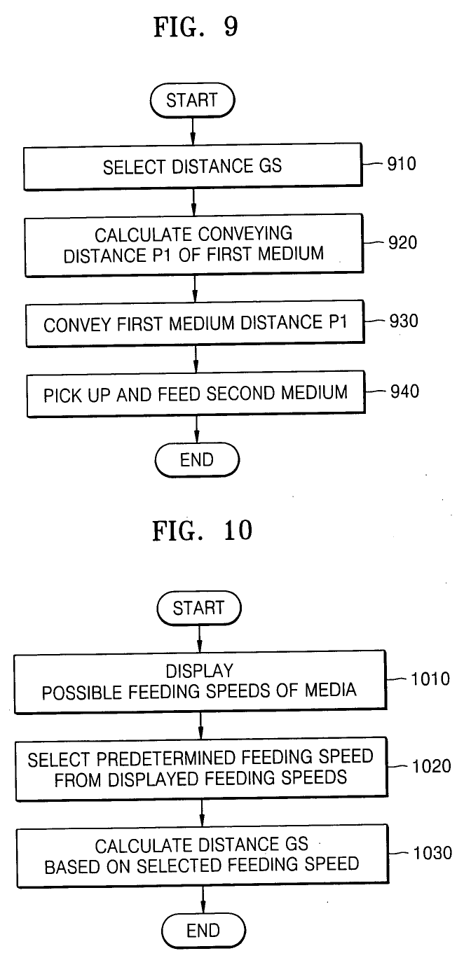

FIG. 9 is a flowchart illustrating a method of continuously feeding media according to an exemplary embodiment of the present invention. Referring to FIG. 9, a distance Gs between a first medium and a second medium is selected through a user interface unit (operation 910 ). The distance Gs is selected by a user command through the user interface unit such as a key pad or a voice input unit. After the first medium is picked up and conveyed based on the selected distance Gs, a predetermined length L1 of a medium and a conveying interval G1 between media, a conveying distance P1 of the first medium for picking up the second medium is calculated (operation 920 ). The front end of the first medium is detected while the first medium is conveyed, and the second medium is picked up and conveyed when the first medium is conveyed the conveying distance P1 after the front end of the first medium is detected (operations 930 and 940 ).

FIG. 10 is a flowchart illustrating in detail the operation of selecting the distance Gs in accordance with an exemplary embodiment of the present invention. Referring to FIG. 10, when the user inputs a command to select a feeding speed of a medium, the feeding speeds are displayed on a display unit (operation 1010 ). The user selects a predetermined feeding speed from the displayed feeding speeds (operation 1020 ). The distance Gs between media is calculated based on the selected feeding speed (operation 1030 ).

According to an exemplary embodiment of the present invention, the display unit allows selection of a high-speed feeding mode, a medium-speed feeding mode, and a low-speed feeding mode, and one of these modes is selected through the user interface unit. Feeding speeds corresponding to the feeding modes are mapped, and the distance between the media is calculated based on the mapped feeding speed.

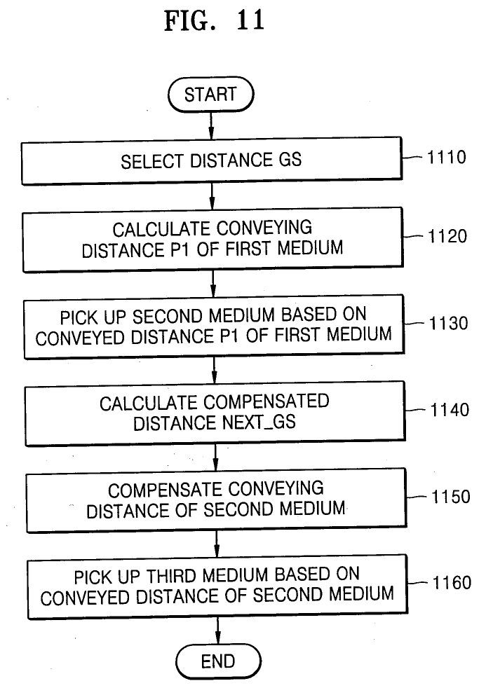

FIG. 11 is flowchart illustrating a method of continuously feeding media according to another exemplary embodiment of the present invention. Referring to FIG. 11, a predetermined feeding speed is selected through a user interface unit (operation 1110 ), and a conveying distance P1 of a first medium at the time when a second medium is picked up based on the selected feeding speed is calculated (operation 1120 ). When the first medium is conveyed the conveying distance P1, the second medium is picked up and fed (operation 1130 ). After the second medium is fed, a compensated distance Next_Gs between the first and second media is calculated to compensate for an error between the selected distance Gs between the first medium and the second medium and a measured distance Gs_curr between the first medium and the second medium. A conveying distance P2 of the second medium at which a third medium is picked up is calculated based on the compensated distance Next_Gs (operation 1150 ). The third medium is picked up and fed based on the compensated conveying distance P2 of the second medium (operation 1160 ).

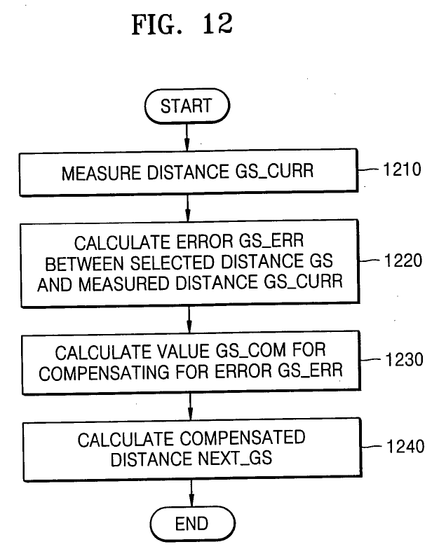

FIG. 12 is a flowchart illustrating in detail the operation ( 1150 ) of calculating the compensated distance Next_Gs in accordance with an exemplary embodiment of the present invention. Referring to FIG. 12, the measured distance Gs_curr between the first and second media is determined by measuring a conveying distance between the rear end of the first medium and the front end of the second medium (operation 1210 ). An error Gs_err between the selected distance Gs and the measured distance Gs_curr is calculated (operation 1220 ). A value Gs_com for compensating for the error Gs_err between the selected distance Gs and the measured distance Gs_curr is calculated (operation 1230 ). To calculate the compensation value Gs_com, a PID control method may be used. The compensation value Gs_com can be calculated using another method in the field to which the present invention pertains without departing from the scope of the present invention. The distance Next_gs between the second medium and the third medium is calculated based on the compensation value Gs_com (operation 1240 ).

The invention can also be embodied as computer-readable code on a computer-readable recording medium. The computer-readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves such as data transmission through the Internet.

According to the present invention, a device and method for substantially continuously feeding media can automatically calculate a distance Gs between media to continuously feed the media according to a feeding speed or feeding mode selected by a user, and thus can feed the media at a higher speed.

Further, a distance between media is substantially continuously compensated for to maintain the feeding speed or feeding mode selected by the user.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of continuously feeding plural media along a print path in an image forming apparatus, the method comprising:
selecting a distance between a first medium and a second medium that are consecutive ones of the plural media along the print path of the image forming apparatus;
calculating a conveying distance of the first medium, at the time when the second medium is picked up for conveyance along the print path after the front end of the first medium is detected, based on the selected distance; and
picking up and feeding the second medium when the first medium has moved the calculated conveying distance.

2. The method of claim 1, further comprising:
displaying feeding speeds of media prior to the selecting the distance.

3. The method of claim 2, wherein the step of selecting the distance comprises:
selecting a predetermined feeding speed from the displayed feeding speeds of media; and
calculating the distance between the media to be conveyed based on the selected feeding speed.

4. The method of claim 3, wherein the distance between the media is calculated using Equation (1),
$$Gs = \frac{60 X}{Y} - L1$$
where X denotes a conveying speed of media in units length per second, Y denotes the feeding speed in units pages per minute selected from the displayed feeding speeds of media, and L1 is the predetermined length of the media.

5. The method of claim 3, wherein the feeding speed is the number of media fed per unit time.

6. The method of claim 3, wherein the feeding speed is selected based on a high-speed feeding mode, a medium-speed feeding mode, and a low-speed feeding mode.

7. The method of claim 3, wherein the conveying distance of the first medium is calculated using Equation (2)
PL=L1−G1+Gs,
where L1 denotes the predetermined length of the media and G1 denotes the predetermined interval between the media.

8. The method of claim 3, wherein the step of picking up and feeding the second medium comprises:
detecting the front end of the first medium;
measuring the conveying distance of the first media after detecting the front end of the first medium; and
picking up and feeding the second medium at the time when the first medium is conveyed as much as the conveying distance.

9. The method of claim 8, further comprising:
calculating a compensated distance to compensate for an error between the selected distance between the first medium and the second medium and a measured distance between the first medium and the second medium; and
compensating for a conveying distance of the second medium at which a third medium is picked up based on the compensated distance.

10. The method of claim 9, wherein the calculating the compensated distance comprises:
measuring a distance between a position where the front end of the first medium is detected and a position where the rear end of the first medium is detected; and
calculating the compensated distance to compensate for the error between the measured distance and the selected distance such that the measured distance is adjusted to the selected distance.

11. The method of claim 10, wherein the error between the measured distance and the selected distance is compensated for using a proportional integral derivative (PID) control method.

12. The method of claim 11, wherein the calculating the compensated distance comprises:
calculating the error between the selected distance and the measured distance;
calculating a value for compensating for the error between the selected distance and the measured distance; and
calculating the compensated distance based on the calculated compensation value.

13. The method of claim 12, wherein the compensated distance for compensating for the error between the selected distance and the measured distance is calculated using Equation (3)
Gs_{—}com=KP Gs_{—}err +KI Gs_{—}err_sum+KD Gs_{—}err_{—}div,
where KP, KI, and KI respectively denote a proportional gain, a integral gain, and a differential gain in a PID control method, and Gs_err_sum denotes the sum of errors between the selected distance and the measured distance, and Gs_err_div denotes the difference between errors between the selected distance and the measured distance.

14. A computer readable recording medium having embodied thereon a computer program comprising:
a first set of instructions for selecting a distance between a first medium and a second medium that are consecutive ones of the plural media along the print path of the image forming apparatus;
a second set of instructions for calculating a conveying distance of the first medium, at the time when the second medium is picked up for conveyance along the print path after the front end of the first medium is detected, based on the selected distance; and
a third set of instructions for picking up and feeding the second medium when the first medium has moved the calculated conveying distance.

15. A device for continuously feeding media along a print path in an image forming apparatus, the device comprising:
a user interface unit for selecting a feeding speed of media;
a calculating unit which calculates a pick-up time of a second medium that is fed subsequent to a first medium based on the selected feeding speed, a predetermined length of media and an interval between media; and
a control unit which controls the second medium to be picked up and fed at the calculated pick-up time of the second medium.

16. The device of claim 15, further comprising:
a display unit which displays possible feeding speeds of the media,
wherein the feeding speed is selected from the displayed feeding speeds.

17. The device of claim 16, wherein the calculating unit comprises:
a first calculating unit which calculates a distance between conveyed media based on the selected feeding speed; and
a second calculating unit which calculates a conveying distance of the first medium based on the calculated distance, the predetermined length of the media, and the interval between the media.

18. The device of claim 17, wherein the distance between conveyed media is calculated using Equation (4)
$$Gs = \frac{60 X}{Y} - 11$$
where X denotes a conveying speed of media in units length per second, Y denotes the feeding speed in units pages per minute selected from the displayed feeding speeds of media, and L1 is the predetermined length of the media.

19. The device of claim 18, wherein the feeding speed is the number of media fed per unit time.

20. The device of claim 18, wherein the feeding speed is selected based on a high-speed feeding mode, a medium-speed feeding mode, and a low-speed feeding mode.

21. The device of claim 18, further comprising:
a storage unit for storing the possible feeding speeds of the media and distances between the media corresponding to the feeding speeds.

22. The device of claim 17, wherein the control unit comprises:
a sensing unit for detecting the front end or the rear end of the conveyed medium;
a counter unit for measuring a conveying distance of the conveyed medium; and
a feed control unit for controlling the picking up of the second medium when the first medium is conveyed as much as the conveying distance of the first medium after detecting the front end of the first medium.

23. The device of claim 22, wherein the conveying distance of the first medium is calculated using Equation (5)
P1=L1−G1+Gs,
where L1 and G1 denote the predetermined length of the media and the predetermined interval between the media, respectively.

24. The device of claim 22, further comprising:
a compensating unit which compensates for an error between the distance calculated by the first calculating unit and a measured distance.

25. The device of claim 24, wherein the compensation unit comprises:
a measuring unit for measuring a distance between a position where the rear end of the first medium is detected and a position where the front end of the second medium is detected; and
an error compensating unit for compensating for an error between the measured distance and the distance calculated by the first calculating unit such that the measured distance is adjusted to the distance calculated by the first calculating unit.

26. The device of claim 25, wherein the error between the measured distance and the selected distance is compensated for by using a proportional integral derivative (PID) control method.

27. The device of claim 26, wherein the error compensating unit comprises:
a third calculating unit for calculating the error between the distance calculated by the first calculating unit and the measured distance;
a fourth calculating unit for calculating a value for compensating for the error between the distance calculated by the first calculating unit and the measured distance using the calculated error; and
a fifth calculating unit for calculating a distance for compensating based on the calculated compensating value,
wherein the second calculating unit calculates the conveying distance of the second medium at which the third medium is picked up based on the compensated distance.

28. The device of claim 27, wherein the value for compensating for the error between the selected distance and the measured distance is calculated using Equation (6)
Gs_{—}com=KP Gs_{—}err+KI Gs_{—}err_sum+KD Gs_{—}err_{—}div,
where KP, KI, and KI respectively denote a proportional gain, a integral gain, and a differential gain in a PID control method, and Gs_err_sum denotes the sum of errors between the selected distance and the measured distance, and Gs_err_div denotes the difference between errors between the selected distance and the measured distance.
